(19) United States
(12) Patent Application Publication
(10) Pub. No.: US 2020/0316921 A1
(43) Pub. Date: Oct. 8, 2020

(54) DEEP-DRAWN MULTILAYER SHEET MATERIAL

(71) Applicant: Benecke-Kaliko AG, Hannover (DE)

(72) Inventors: Dirk Harald Mielke, Hemmingen (DE); Guenter Leo Proempers, Garbsen (DE)

(73) Assignee: Benecke-Kaliko AG, Hannover (DE)

(21) Appl. No.: 16/304,152

(22) PCT Filed: Feb. 27, 2017
(86) PCT No.: PCT/EP2017/054456

§ 371 Date: Nov. 22, 2018

(30) Foreign Application Priority Data
May 24, 2016 (DE) 10 2016 208 963.3

(51) Int. Cl. B32B 27/06; B32B 5/18; B32B 21/04; B32B 27/30; B32B 27/20

(52) U.S. Cl. CPC B32B 27/065; B32B 5/18; B32B 21/047; B32B 27/304; B32B 27/205; B32B 2605/003; B60R 13/0243; B32B 2451/00; B32B 2255/10; B32B 2255/26; B32B 2264/025; B32B 2266/0235; B32B 2274/00

(57) ABSTRACT

The invention relates to a deep-drawn multilayer sheet material which at least comprises one backing layer and one foamed layer based on polyvinyl chloride. The deep-drawn multilayer sheet material is used as interior cladding part for a vehicle. In particular, the foamed PVC layer comprises hollow microspheres in order to reduce unpleasant odours.

The invention relates to a deep-drawn multilayer sheet material which at least comprises one backing layer and one foamed layer based on polyvinyl chloride. The deep-drawn multilayer sheet material is used as internal cladding part for a vehicle.

Sheet materials with a foamed outer layer based on polyvinyl chloride (PVC) are already known for the internal cladding of motor vehicles, as surfaces for instrument panels, door side cladding, column cladding, etc. The sheet materials usually have a multilayer and often have foam on their reverse sides or have been laminated to components and have, on their upper side, a three-dimensionally structured, embossed surface, known as a pattern or grain in a very wide variety of forms and embodiments. The multilayer structure often consists of an upper optionally lacquered outer or decorative layer, which has been embossed, optionally a foamed layer and optionally a reverse-side primer. The primer serves to improve adhesive bonding or adhesion of foam to the backing.

In particular for the use of the sheet materials as interior cladding of motor vehicles, the grained sheet materials are deep-drawn, i.e. moulded.

The deep-drawn components of the internal cladding are therefore not synthetic leather, which must always comprise a textile backing, and in the automobile interior is mostly used only for the area on which occupants sit. Synthetic layers must have a certain flexibility and extensibility, and can be treated as leather, and therefore for example can be stitched like leather. Synthetic leathers of the type found in, for example, EP 2 918 629 A1, DE 10 2014 110 813 A1, DE 10 2014 110 814 A1 and DE 10 2014 110 815 A1 are generally not mouldable, and cannot therefore be deep-drawn without destroying the structure and properties of the synthetic leather. The textile backing does not withstand the high degrees of stretching that occur during the deep drawing procedure.

In the case of the deep-drawn multilayer sheet materials with a layer based on PVC, the PVC layer is mostly foamed. This is achieved by using azodicarbonamide (ADCA). During the foaming process and the ADCA decomposition reaction associated therewith, decomposition compounds are produced that give the product an unpleasant odour. The use of azodicarbonamide is moreover classified as “having a sensitizing effect on the respiratory system”, and has been included by the European Chemicals Agency (ECHA) in the authorization list (Annex XIV) on grounds of “Equivalent Level of Concern” (ELoC), for inclusion in the REACH regulations.

The present invention is therefore based on the object of providing a deep-drawn multilayer sheet material, which is not a synthetic leather, with at least one foamed layer, hereinafter also termed foam layer, based on PVC, which is not hazardous to health and which does not release any unpleasant odours.

The object is achieved in the invention in that the foamed layer of the deep-drawn multilayer sheet material at least comprises one polyvinyl chloride and hollow microspheres.

As already mentioned, the deep-drawn multilayer sheet material is not a synthetic leather. In accordance with DIN 16 922 (1981), paragraph 2.1.1, a synthetic leather, another term for which textile material manufactured using plastics, must comprise at least one layer made of flexible textile sheet materials. The deep-drawn multilayer sheet material of the invention is, however, not a synthetic leather and is therefore free from textile layers and flexible textile sheet materials.

Surprisingly, it has been found that the combination of PVC and hollow microspheres permits production of a PVC layer with foam structure that is not hazardous to health and, in particular, does not release any unpleasant odours.

The sheet material can be produced in any of the familiar colours and grains.

The use of the hollow microspheres in the PVC foam layer provides the necessary foaming of the product, in order to achieve the required haptic properties and the corresponding weight saving. The extent to which the hollow microspheres expand during the foaming process is about 3.5 times their initial size. No decomposition products that can give the product an unpleasant odour are produced during this procedure. This leads to improved odour in the automobile interior.

The use of the hollow microspheres, which expand at a temperature of from 110 to 180° C., depending on the type, moreover provides greater homogeneity of foaming behaviour in the PVC matrix when comparison is made with azodicarbonamide-foamed PVC foam layers, which give a bathtub profile across the width because of the higher activation energy.

When the hollow microspheres hollow microspheres are used, size-related reasons prevent migration, into the compact topcoat of any possible residues of other chemical foaming agents or blowing agents. Foaming of the topcoat at the boundary layer is thus supressed, and there is a clearly defined boundary layer present between topcoat and intermediate coat. Better embossing results can thus be achieved at a higher speed, and even with low topcoat thicknesses it is possible to avoid microblisters that lead to defects on the surface. A particularly clearly defined boundary layer can be achieved by excluding other chemical blowing agents, in particular ADCA, from the PVC foam layer. The quantity of other chemical blowing agents is therefore preferably 0% by weight, based on the respective formulation.

A preferred quantity of PVC that can be used, based on the formulation of the PVC foam layer, is from 35 to 65% by weight.

The polyvinyl chloride here can preferably take the form of SPVC, which is produced industrially via suspension polymerization, or of EPVC, which is produced industrially via emulsion polymerization, or of MPVC, which is produced by bulk polymerization or mass polymerization, or MSPVC, which is produced by the microsuspension process.

The PVC foam layer in the invention comprises hollow microspheres. Quantities preferably used of these are from 0.5 to 5% by weight, particularly preferably from 0.6 to 2.5% by weight, based on the formulation of the PVC foam layer.

The hollow microspheres can be used in expanded or non-expanded form. They are preferably non-expanded, i.e. expandable, hollow microspheres, in particular made of glass, phenolic resin or carbon. However, it is preferable to use hollow microspheres made of thermoplastic material. These have a certain resilience and are more successful in withstanding the shear forces during the mixing process.

It is preferable that the thermoplastic material is at least one acrylonitrile polymer. Hollow microspheres of this type are obtainable inter alia with trademark Expancel® from Akzo Nobel or with trademark Advancell® from Sekisui.

The PVC foam layer present in the deep-drawn sheet material additionally comprises the conventional additives, for example plasticizers, stabilizers, ageing retarders, (e.g. antioxidants), fillers, flame retardants (e.g. antimony trioxide or zinc hydroxystannate), pigments (e.g. carbon black, titanium dioxide) and other ancillary substances (e.g. viscosity aids, adhesion promoters, etc.).

The deep-drawn sheet materials of the invention can comprise further layers, for example unfoamed layers as decorative layer or topcoat. These further layers are preferably based on polymers such as polyurethane, PVC or thermoplastic polyolefins. likewise possible polymers other than PVC present, for example polyurethane, thermoplastic polyolefins.

Deep-drawn multilayer sheet materials can moreover have a lacquer layer, facing outward, applying to the outer layer. Lacquers used can be those by way of example based on polyurethane (PU or PUR), PVC/acrylate or acrylate.

The draw factor of the deep-drawn multilayer sheet material of the invention is preferably from 1 to 200%, particularly preferably from 10 to 150%. The draw factor is the change from the initial condition of the sheet material after it has been subjected to a forming procedure.

The deep-drawn multilayer sheet material comprises at least one backing layer. Backing layer used can by way of example be wood-fibre-composite materials or layers based on at least one thermoplastic or thermoplastic elastomer. Thermoplastics and thermoplastic elastomers that can be used are by way of example PP, PVC-ABS, PC, PUR.

The deep-drawn multilayer sheet material can be subjected to a forming procedure via processes such as thermoforming, in-mould graining, low-pressure moulding or press-lamination, to give a desired three-dimensional surface. These products produced by a three-dimensional forming procedure are inter alia used in aircrafts, rail vehicles, ships and motor vehicles.

The deep-drawn sheet material of the invention can be used particularly advantageously for a motor vehicle as interior cladding part on which occupants do not sit, in particular for dashboards, door cladding, centre consoles, parcel shelves, rear walls of seats, column cladding, for example for ABC columns, and armrests.

### EXAMPLE OF FORMULATION FOR A PVC FOAM LAYER OF THE INVENTION

100 phr of PVC (MPVC, EPVC, SPVC, MSPVC)

80 phr of plasticizer (DIDP)

2 phr of stabilizer (CaZn)

2.5 phr of hollow microspheres

from 1 to 5 phr of pigments

(phr=parts per hundred parts of rubber)

This example of a formulation was used in a sheet material of the invention. The sheet material additionally comprises an unfoamed decorative layer based on PVC. The sheet material was then applied to a backing and grained. This grained sheet material was used in a Kiefel deep-draw system at 165° C. to produce a three-dimensional roof shape with draw factors of from 50 to 60%. The roof shape simulates door cladding in a car interior. way of these amendments. The following listing of claims will replace all prior versions, and listings, of claims:

1.-5. (canceled)

6. A deep-drawn multilayer sheet material which at least comprises one backing layer and one foamed layer based on polyvinyl chloride, wherein the foamed layer comprises hollow microspheres.

7. The deep-drawn multilayer sheet material as claimed in claim 6, wherein the foamed layer comprises from 0.5 to 5% by weight of hollow microspheres, based on the formulation of the foamed layer.

8. The deep-drawn multilayer sheet material as claimed in claim 6, wherein the foamed layer is free from additional chemical blowing agents.

9. The deep-drawn multilayer sheet material as claimed in claim 6, wherein that it is an internal cladding part for a vehicle.

10. An interior cladding part for a vehicle, consisting of a deep-drawn multilayer sheet material as claimed in claim 6.

11. The deep-drawn multilayer sheet material as claimed in claim 6, wherein the foamed layer is free from azodicarbonamide (ADCA).

12. The deep-drawn multilayer sheet material as claimed in claim 6, wherein the foamed layer comprises hollow microspheres expanded to about 3.5 times of their initial size.

13. The deep-drawn multilayer sheet material as claimed in claim 6, wherein the foamed layer is a topcoat layer disposed adjacent an intermediate layer, wherein there is a clearly defined boundary layer present between the topcoat layer and the intermediate layer, and

14. The deep-drawn multilayer sheet material as claimed in claim 13, wherein the topcoat layer is free of microblisters on its surface.

15. The deep-drawn multilayer sheet material as claimed in claim 6, wherein the hollow microspheres are a thermoplastic material.

16. The deep-drawn multilayer sheet material as claimed in claim 6, wherein the thermoplastic material is an acrylonitrile polymer.

17. The deep-drawn multilayer sheet material as claimed in claim 6, wherein the backing layer comprises a wood-fibre-composite material.

18. The deep-drawn multilayer sheet material as claimed in claim 6, wherein the backing layer comprises at least one thermoplastic elastomer.

20. The deep-drawn multilayer sheet material as claimed in claim 6, wherein the deep-drawn multilayer sheet material further includes an unfoamed decorative layer based on PVC disposed adjacent the foamed layer on an opposing side from the backing layer.

21. An interior door cladding part for a vehicle, consisting of a deep-drawn multilayer sheet material as claimed in claim 20.
